(19) United States
(12) Patent Application Publication
(10) Pub. No.: US 2008/0052213 A1
(43) Pub. Date: Feb. 28, 2008

(54) Method and Apparatus for Modeling and Executing Deferred Award Instrument Plan

(75) Inventor: Lawrence L. Bell, Chevy Chase, MD (US)

Correspondence Address: EDELL, SHAPIRO & FINNAN, LLC, 1901 RESEARCH BOULEVARD, SUITE 400, ROCKVILLE, MD, 20850, US

(73) Assignee: Lawrence L. Bell, Chevy Chase, MD (US)

(21) Appl. No.: 11/930,920

(22) Filed: Oct. 31, 2007

Related U.S. Application Data
(63) Continuation-in-part of application No. 10/601,649, filed on Jun. 24, 2003.
Application No. 10/601,649 is a continuation-in-part of application No. 09/690,891, filed on Oct. 18, 2000, now Pat. No. 6,609,111.
Application No. 09/690,891 is a continuation-in-part of application No. 09/177,131, filed on Oct. 22, 1998, now Pat. No. 6,161,096.

(51) Int. Cl. G06Q 40/00

(52) U.S. Cl. 705/36 R; 705/1; 705/35

(57) ABSTRACT

Administration of various deferred award instrument plan and asset account programs that can effectively provide economically efficient benefits by assisting an Employer in the identification of appropriate employees, and through the use of a novel modeling method and apparatus to implement a deferred award instrument program through a novel employee welfare benefit/deferred compensation/EWB/OPEB asset account maintenance plan that permits the employees to benefit from their deferred award incentive program (such as stock options, Long Term Incentive Plans, deferred compensation, EWB/OPEB, life insurance benefits), while having a minimal financial impact on the Employer.

This application is a continuation-in-part of U.S. patent application Ser. No. 10/601,649, filed Jun. 24, 2003, which is a continuation-in-part of U.S. patent application Ser. No. 09/690,891, filed Oct. 18, 2000, now U.S. Pat. No. 6,609,111, which is a continuation-in-part of U.S. patent application Ser. No. 09/177,131, filed Oct. 22, 1998, now U.S. Pat. No. 6,161,096.

### I. BACKGROUND

A. Field of the Invention

The present invention relates to a computer system and method for modeling and administrating a deferred award instrument plan. A deferred award instrument plan is defined as a plan described by Financial Accounting Standards (FASB), International Accounting Standards (IAS) and Governmental Accounting Standards (GAS) and by their respective boards (FASB, IASB and GASB) that provides a current and/or future benefit for current or retired employees and their dependents.

B. Background of the Art

Increased competition among Employers or Companies (Employers include for profit,non profit,governmental entities) has led to the use of deferred awards, stock options, life insurance post retiree benefits (OPEB),and deferred compensation as a tool to both recruit and maintain loyal and highly skilled labor. Stock options are used as forms of compensation that reward employees for their labor. Employers (for profit, non profit, governmental-referred to collectively as “Employer”) grant employees the benefits and stock where applicable to reward current and future efforts. As new products or services are introduced the stock price rises, the employee's stock options, Long Term Incentive Plan (LTIP), (OPEB), deferred compensation and other benefits (referred to as Benefits), for example, may be given for past service or as incentive for future performance.

An example of benefits measurement and timing issues are when Benefits are granted, the price at which the employee has the right to purchase the stock or the value of the asset received hereinafter referred to as the “gain”. If the options are not exercised in a predetermined period of time, they often lapse. The difference between the Grant Price and the trade price of the stock in the appropriate exchange, or the Benefit (hereinafter “Market Price” of “FMV”). The measurement has become more sophisticated as information has become more readily available. For example: Stochastic Modeling has become a mainstream tool in the EU, Asia and most recently in the US

There are several different types of Benefits that can be granted. Benefits may be Qualified or Nonqualified, they are governed for example but not by way of limitation by Sections 422, 424, Deferred Compensation Sections 83, 409A and 457 and other benefit provisions of the United States Tax Code as well as accounting principles under FASB, IASB and GASB.

There are numerous reasons for example why it is not desirable to generate too many benefits and/or have them recognized or exercised. First, the limited life of most options of current employee related fringe benefits have cash liquidity ramifications on the employee. The selling of stock to cover stock option costs by key employees can have a negative impact on the company.

A second downside is the recognition of Benefits is the effect on the balance sheet and financial accounting.

The greater number or amount of Benefits recognized the larger the problem becomes. If an employee does not have enough cash to satisfy the Grant Price and taxes associated with an exercise, the employee is forced to sell stock, which only aggravates the tax consequences and reflects poorly on the company.

Many of the issues associated with stock option plans are also present with other benefit and deferred compensation programs offered by companies today. Also complying with not only FASB, IASB, GASB announcements(FAS 87, 106, 123158 AO 25 IAS 19, GASB 25,27 and 43,45 EITF, 06-04 and 06-05) creates bothersome compliance issues. Many of these programs also require a significant outlay by the company to compensate or reward an employee or member. These outlays can detract from a company's bottom line in the near term. What is therefore needed in the art is a new program, method and apparatus by which a company can compensate its best employees over an extended period, thus minimizing the effect on the employee while at the same time allowing the company to have minimal effect on its financial statements with the administration of these Benefit programs and bring programs into harmony with GASB, FASB and IASB.

### II. SUMMARY OF THE INVENTION

The present invention is directed to solving the aforesaid problems by providing a unique computer system and computer program for assisting the company's identification of appropriate employees, through the use of a novel modeling method and apparatus. Another aspect of the invention includes a program that permits the employee to benefit from his/her deferred compensation and award or Benefits programs, while having a minimal impact on charge to earnings on the company. Further, the present invention includes systems that implement a financial management plan for avoiding Corporate-Owned Life Insurance (COLI) excesses as related in the Wall Street Journal and the Enron/Anderson scandals and the Joint Committee Report. The present invention also provides a global harmonization of benefits that minimizes expense and maximizes employee benefits, and not create a charge to earnings. The present invention will meet FASB 87,106,158,GASB 25,27 and 43 and 45 and IASB 19 standards for employee benefits without creating a substantial charge to earnings.

Briefly described, the present invention provides an automated Plan that permits employees to benefit from their stock options, or other Benefits programs, while minimizing the negative impact on the company. The invention also provides a UNIQUE SOLUTION® Plan for profit and non-profit/not-for-profit employer under Section 501(c) and other entities (hereinafter sometimes referred to as Companies or Employers) and will also be encompassed hereinafter for simplicity by the term “UNIQUE SOLUTION® Plan”), as well as a combination UNIQUE SOLUTION®/Employee Welfare Benefit or Post Retiree Benefits under FAS 106 and 158.

Benefit/115Trust/Voluntary Employee Benefit Association (VEBA)/qualified and nonqualified (referred hereinafter as EWB) Plans that additionally allows a company to take maximum advantage of benefits which may be associated with the plans. The present invention comprises a method and system for modeling the programs to determine if the programs are appropriate for a given individual or group and the company, as well as a method of maintaining and operating the individual elements of the invention.

A further object of the present invention is to provide a method and computer system for identifying individuals or groups from a predetermined pool that fit predetermined company goals for inclusion in the UNIQUE SOLUTION®, and the combination UNIQUE SOLUTION®/EWB Plan.

A further object of the present invention is to provide a method and computer system for the effective and efficient financial accounting management and stochastic modeling to implement the UNIQUE SOLUTION® Plan, and the combination UNIQUE SOLUTION®/EWB Plan.

The present invention is directed to a method for identifying and administering deferred award instrument plans through a computer system, said method comprising the steps of: identifying at least one participant in said deferred award instrument plan; retrieving financial data related to Benefits corresponding to said identified participant and to an EWB pursuant to a Benefit plan for said participant; determining actuarial reasonable costs for a current death benefit; where necessary, computing a gain or spread associated with said deferred award; establishing financial accounting for said award if appropriate and/or necessary; determining whether a life insurance policy has been purchased by or on behalf of said participant, said life insurance policy combining features of a deferred award incentive plan or asset accumulation and an EWB; determining whether an endorsement has been executed; monitoring and paying at least one premium for said life insurance policy; and notifying said participant that an nth payment associated with said life insurance policy has been paid. After the nth payment has been made, the employee or employer, depending on who owns the policy, may borrow, take advances or withdrawals against the policy in accordance with insurance and benefit rules.

The present invention is also directed to a method of modeling deferred award instrument plan programs comprising the steps of: inputting models factors; retrieving human resource data; retrieving deferred award data; asset accumulation data and EWB data; retrieving fair market value information relating to said data; computing company cost and length of program using amongst many tools stochastic methods; and storing said retrieved and computed data. The method may also include converting said human resource data to a deferred award instrument plan format or converting said Benefits and/or said EWB data to a deferred award instrument plan format.

It is also contemplated that the present invention may include inputting weighing indicators by way of example but not limited to stochastic methods corresponding to said model factors and displaying at least a predetermined portion of said retrieved and stored data based on said weighing indicators.

The present invention is also directed to an apparatus for implementing a deferred award instrument plan comprising: a processor; memory operationally attached to said processor; an input device operationally attached to said processor; a display device operationally attached to said processor; and wherein said memory comprises a deferred award instrument plan program that is configured to perform the steps of inputting models factors; retrieving human resource data; retrieving deferred compensation asset accumulation and employee welfare benefit plan data; retrieving fair market value information relating to said data; computing company cost and length of program; and storing said retrieved and computed data.

With these and other objectives, advantages and features of the invention that may become apparent, the nature of the invention may be more clearly understood by reference to the following detailed description of the invention, the appended claims, and to the several drawings attached herein.

### III. BRIEF DESCRIPTION OF THE DRAWINGS

FIG. 1 is an apparatus for implementing the modeling program;

FIG. 2 is a schematic flow of the preferred embodiment of the computer program;

FIG. 3 is a flow chart of the UNIQUE SOLUTION® Plan modeling program of the present invention;

FIG. 4 is a flow chart of the financial accounting maintenance and operating program; and

FIG. 5 is a flow chart of a second embodiment (UNIQUE SOLUTION®, of the present invention.

FIG. 6 is a chart showing costs, benefits and values for an alternate UNIQUE SOLUTION®/EWB plan and policy according to a third embodiment of the invention.

### IV. DETAILED DESCRIPTION OF THE INVENTION AND OF THE PREFERRED EMBODIMENTS

The present invention may be implemented in whole, or in part, on a computer with a Pentium processor, hard drive, 16 Mb of RAM and by running an operation system comparable to Windows '95. It is expressly contemplated that at least one monitor is attached. Preferably a printer, modem and overhead projector are also attached thereto. It is expressly contemplated that the present invention may be implemented on a dedicated computer system. At least one input is provided for receiving modeling parameters. It should be noted that any combination of computer hardware (processor, monitor, memory, server, network, etc.) can be used to create the building blocks of the present system, as shown. It should also be noted that any of the software functions, steps or elements described herein can be implemented in any conventionally known computer.

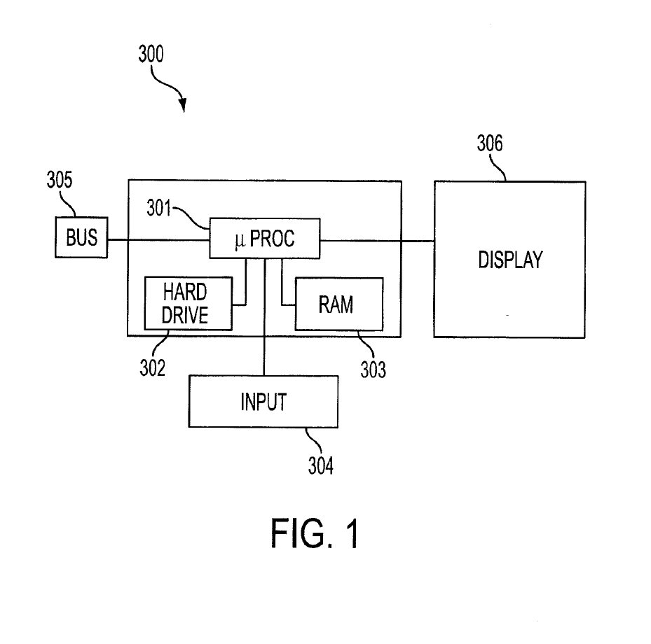

A preferred embodiment of a financial management account using stochastic modeling to carry out the program is shown in FIG. 1. A processor 301 is provided with a hard drive 302 and RAM 303. The hard drive 302 may be used to store predefined processes or data. The processor 300 is operationally connected to a manual input means, such as a keyboard and/or mouse 304. A bus 305 is provided that may comprise a conventional bus, infrared communication port, modem or the like. The bus 305 may be used to operationally attach the apparatus 300 to a modem, database or other source of data. A display or projector 306 is operationally connected to the processor 301. Those of ordinary skill in the art will realize that this is but one embodiment of an apparatus capable of implementing the modeling program using stochastic method and other methodologies and/or Rabbi Trust management program and that this embodiment may be modified using conventional components.

The present invention analyzes data that may be input and stored on the hard drive or that may be retrieved from other databases. It is expressly contemplated that the present invention may be designed to interface with an Employer's human resource (HR) data files to extract employee-related information. Extraction of HR data may be performed with the modeling program, in advance of running the modeling program, or after an initial set of modeling parameters has been input, but before final modeling factors are decided upon. It is expressly contemplated that financial information may likewise be obtained from a company's database, commercially available database, or retrieved from financial data stored on a computer's hard drive (not shown).

A. Program

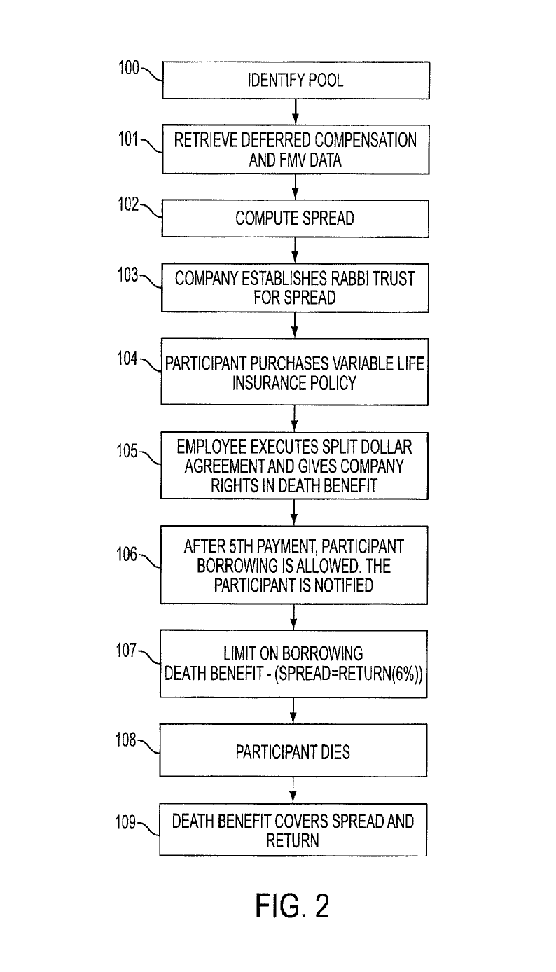

The steps of the program forming the preferred embodiment are set forth in FIG. 2. Although the steps are shown in order of intended implementation, those of ordinary skill will recognize that the steps in some cases may be rearranged or performed simultaneously.

The program is preferably designed to work with a for profit corporation, but it is expressly contemplated that the program, modeling program and financial management administration program and stochastic modeling (hereinafter referred to as asset account) may be used in other applicable settings. For example, they can be implemented by a consulting company, insurance company, professional service company, partnership, Limited Liability Company, Limited Partnership, any pass-through entity, non-profit and or, 501(c) organizations including governmental organizations for its employees and members, trust company, or any combination thereof. Other employer and corporate entities are also contemplated herein. The program generally maintains a qualified or non-qualified deferred compensation or LTIP and Benefits plan (“Plan”), e.g. a stock option plan deferred awards, asset accumulation or other LTIP plan such as life insurance benefits and OPEB, EWB, for the benefit of its employees and members,

The Plan provides an incentive for the employees, officers, directors and other key and loyal employees of the Employer to join or remain in the employment of the Employer and/or to maintain and enhance the Employer's long-term performance record through offering incentive awards. The Plan authorizes the Employer to issue Benefits to employees/members and qualifying non-employee directors and members (together, “Employees”) who are participants. In the case of stock options, the plan would permit an Employee to purchase a share of the Employer's common stock (“Common Stock”) for a price equal to the fair market value of the Common Stock on the date of issuance. An Employee cannot transfer the stock options under the Plan other than by gift or assignment, and the Employees, as holders of a stock option under the Plan, do not receive the rights of shareholders until they exercise the stock option and the Employer issues the shares.

Due to the significant value of the stock options, LTIP and Benefits after being exercised and the fact that the ownership of the Employer will change after the stock issuance, and the deferred award instrument plan or endorsement or co-ownership agreement the Employer desires to modify the terms of the Plan (“Modified Plan”) to enable the Employer to take certain actions with regard to the outstanding, but unexercised, stock options, as well as other benefits. The Modified Plan will enable the Employer to preserve the current ownership of the Employer and at the same time receive positive balance sheet and accounting benefits, a UNIQUE SOLUTION® Plan, and/or a combination UNIQUE SOLUTION®/EWB/OPEB, Benefits/Plan, Stochastic Method Allocation Retention &Retirement Target® (SMART® Planning) (the “Alternate” Plan as hereinafter described). In order to determine whether modification is appropriate, the Employer will perform a cost analysis of the programs using stochastic modeling and other financial applications to determine if the programs are consistent with the Employer's goals.

Under the Program, the Employer will provide the following modifications to the Plan. When an Employee exercises his or her option if necessary by providing notice under the Alternate Plan to the Employer, the Employee will be making an election to receive benefits, which may include cash, at a subsequent time. The Employer will determine whether the value of the benefit exceeds an exercise price of more than a dollar amount (the “Threshold”) determined by the Employer. The Employer has determined that the exercise of many benefits under the Plan greater than the Threshold will be detrimental to the cash flow of the Employer since the Employer must use its resources to acquire the benefit that has a purchase price greater than the original cost. In addition, the exercise of many options or benefits may result in a change of majority control of the Employer or adversely affect the balance sheet or income statement. By controlling the issuance of benefits pursuant to the Alternate Plan, the Employer can also engage in better long-range planning based on benefits accounting reporting and management of the Company. The Employer has proposed the modifications contained in the Alternate Plan to provide a fair and equitable means to minimize the detrimental effect of the exercise of the options, distribution of benefits and charge to earnings on the Employer.

Options or Benefits greater than the Threshold will be the same as the original options or benefits except that the Employer (i) will reflect the gain for accounting purposes to provide the benefits under the Alternate Plan; (ii) the Employee will agree to purchase or provide the benefits from the Plan and Alternate Plan; and (iii) the Employee will not receive stock upon exercise of the options or LTIP. As additional consideration for having Employee consent to the terms of the Modified Plan, the Employer may convert the arrangement into a deferred award or an asset accumulation devise. The options under the Alternate Plan will not have a fair market value when granted and upon a triggering event the Alternate Plan with release of its endorsement.

In another embodiment of the invention, the Employer will determine if a EWB Plan, more preferably an is applicable to the Employee or member (Employer). Under the EWB Plan, the Employer will fund the premiums on a group-term life insurance benefit basic on the Employee or Member. The life insurance benefit has no cash surrender or accrual value, and may be funded over the working life of each Employee or Member covered. Under current and proposed Internal Revenue Service regulations, the cost of the premiums paid for the EWB Plan life insurance benefit is fully deductible to the Employer when paid. Under these circumstances, the life insurance benefit may be described as a death benefit for the Employee or Member. Upon termination of participation by the Employee or Member, the owner of the policy retains ownership with the lapsing of the endorsement and is entitled to all benefits associated with the policy.

Additionally, the Employer may also fund a deferred award instrument plan for the Employee, which is similar to the Plan described above, but which does not necessarily involve stock or stock options. This deferred award instrument plan may be more broadly referred to as the UNIQUE SOLUTION®. Like the above described Plan, the UNIQUE SOLUTION® plan will work to minimize adverse effectives to the Employee, but unlike the above described Plan, can involve any type of deferred award or asset accumulation, e.g. such as life insurance. This deferred award instrument plan or UNIQUE SOLUTION® Plan or Alternate Plan will also require contributions which will typically be made by the Employer. The UNIQUE SOLUTION® Plan can take the form of a life insurance policy to be owned by the Employee or Employer. After an nth payment for the premium for the current death benefit life insurance has been made and the Employee is not longer in the EWB, the Employer may retain ownership of the benefit.

The policy will allow the owner to borrow against the accrued cash value which is associated therewith.

When the deferred award instrument plan just described for the UNIQUE SOLUTION® Plan is utilized with a non-profit employer, corporation 501(c) for its employees or members or any pass-through or other entity the Plan complies with Internal Revenue Service Code Sections 61, 83, 101(j), 409A and its final regulations, §457(f)(2)(c) and §457(e)(11) Notice 2005-1, Table 2001 and GASB, FASB, and IASB.

The Alternate Plan combines some of the preferred features associated with the EWB Plan and the deferred award instrument plan THE UNIQUE SOLUTION®. According to this hybrid plan, premiums are actuarially determined in line with Section 419A (2) for the Employee and are split into two categories for payment. Actuarially determined premium payments which go into the EWB Plan portion are managed separately from those that go towards the UNIQUE SOLUTION® portion premiums. The Employer can receive the full tax deduction for the EWB premiums when contributed. The asset account will create no charge to earnings as previously described can be established to fund the other premiums, i.e. to ensure that any gain associated therewith is adequately funded and reflected on the books of the company. Depending on how the policy is owned, the Employer or Employee may borrow against the cash value of the UNIQUE SOLUTION® portion, and incur little tax liability. If the amount borrowed is not paid back before the Employee's death, then that amount is simply deducted from the death benefit.

Thus as shown in FIG. 2, the first step in the program is to identify the pool 100 of candidates who will be evaluated for participation in the program. The Employer may wish to evaluate a number of different employees from conventional HR data to determine what financial impact participation all or part of the pool will have. The total level of compensation, the number of stock options held, the age of the employee or other factors may be used by the Employer to decide which employees to place in the pool of candidates who will be considered for participation in any of the plans.

After the pool is identified, the next step is to retrieve identified employees' Benefits or asset accumulation data 101. The Benefits or asset accumulation data may include the amount of stock options they have been awarded, the type of exercisable option it is, the expiration date of the option, the grant price, the benefits provided or accrued, the participant's age and other relevant human resource data. In this step, the Fair Market Value of the stock may be determined or the fair value of benefits is projected. In the modeling application, it may be preferable to project what range a company's stock may fall in during a given time frame. If the Employer's data is kept in a format that is compatible with the implementing software and hardware, the data can be directly imported from the Employer. It is expressly contemplated that an extraction module can be used that places the Employer's data in the form required by the program's implementing software and hardware.

In the case of the UNIQUE SOLUTION® or Alternate Plans, other information may have to be retrieved pursuant to step 101 relating to deferred award instrument plans or asset accumulation as well as to EWB data. For example, actuarial data relating to the Employee may also be necessary, such as projected life expectancy based on health risk factors, the amount of death benefit and the like. This information will be necessary to help determine the cost of the benefit, associated with the EWB portion of the Alternate Plan.

In step 102 the Spread is determined by calculating the difference between the Strike Price and the FMV or projected Fair Value or Market Price. As the decision to enter the program is made in advance of its implementation, the implementing software and hardware can be capable of predicting a range of stock prices over a given period of time that is in keeping with the Employer's objectives. This Fair Value Market Price predictor may be part of the present system or integrally provided therewith from commercially available investment data sources.

In the case of a UNIQUE SOLUTION® or Alternate Plan for step 102, other ways of calculating the Spread or gain may be chosen. For example, under these plans the Spread may simply be the level of deferred compensation or extended income which the Employer has agreed to provide to the Employee. In other circumstances, the Spread may equal the cost of the premiums necessary to purchase and maintain a certain monetary level of life insurance for the Employee pursuant to the Plan. In this way, the Employer will know what the cost of funding the premiums associated with the life insurance policy will be.

When the UNIQUE SOLUTION® or Alternate Plan is implemented, the next step is to establish financial accounting management system which may use stochastic methods 103.

The Employee participant then purchases a life insurance policy (the Policy) at step 104. Alternatively the Policy may be purchased on behalf of the Employee, by the Employer for example. Under the asset account component, the Employer will carry the Spread or gain (e.g., the cost of the premiums) on the books of the company established on behalf of the participant. The Employer will establish the asset account to provide a source of funds to the Policy owned by the Employer or Employee on the life of the Employee. The Spread deposited into the asset account must be sufficient to pay each year the portion of the annual policy premium equal to the cost of the life insurance protection provided under the Policy but not necessarily the cost of the current death benefit. The owner would maintain the Policy during his or her lifetime to avoid loss of the benefit. Any benefit and increases under the Policy will be the sole and exclusive property of the owner.

Under THE UNIQUE SOLUTION® Plan the Employee and/or the Employer pursuant to the Endorsement will contribute sufficient premium payments under the Policy over the employer members working life, so that the life insurance protection provided under the Policy is maintained. Each year the Employee or Member receives an economic benefit. Such notice can be automatically generated by the computer system. This assures death benefits for the Employee or Member so long as the endorsement is in effect. Thus, the owner may borrow the cash value from the policy under the UNIQUE SOLUTION® Plan or the UNIQUE SOLUTION® portion of the Alternate Plan. The death proceeds will be paid to the Employee's beneficiaries in line with the endorsement and or co-ownership agreement. The Employer will not be required to issue any further benefits to the Employee or Member under the Modified Plan as previously described. Instead, the benefit may take the form of the life insurance benefits just described.

The asset account provides satisfactory assurance to the Employee that the Spread or gain has been segregated to provide the benefits identified in the Program. The asset account is not intended to have a tax effect on the Employee and may be placed in a Rabbi Trust, and the funds within the asset account will not create a substantial charge to earnings. Under the Alternate Plan, the asset account ensures that only the Benefits are paid. Those contributions which fund the EWB are maintained separately and apart from the asset account. As set forth above, the contributions paid into the asset account will not create a substantial charge to earnings or the Employee. Maintaining the contributions separately thus helps to maintain this favorable treatment from the PBGC and FASB/IASB/GASB accounting.

When the Policy is purchased a co-ownership endorsement is executed 105 that gives the EWB the right to receive at least a portion of the death benefit associated with the Policy. The Policy can be purchased online, using interactive capabilities of, for example, the Internet. The Company receives that portion of the death benefit equal to the portion not paid for by the EWB, those amounts are annually actuarially determined.

Under this co-ownership endorsement, which can be administered by the computer program, each year the Employer or the Employee will pay the portion of the annual policy premium equal to the cost of the life insurance protection under the Policy offset by the cost of the current death benefit, actuarially determined and paid by the EWB. The Employer or the Employee will apply the difference to the obligation, but the Employee or Employer is liable for any shortfall in the premium depending upon who is the co-owner of the policy. Any surplus of Spread after the payment of the policy premiums necessary to pay the costs of the life insurance protection under the Policy will be the sole and exclusive property of the asset account. The co-ownership endorsement requires the Employer or Employee to advance the remainder of the annual premium for the working life of the participant.

After termination of the Employee or Member from the plan (step 106) the participant is notified by an appropriate output (e-mail, intranet posting, automatic written letter, etc.). The owner's borrowing however is limited at step 107 that analyzes the insurance death benefit and compares that with the Spread or gain.

The asset account administration software may also be used to monitor the Policy and ensure that all-applicable tax or other obligations that may effect the Employer's and Participant's rights are attended to. Any factor, such as payment of any taxes related to the §61, 83, 101(j),409A 457(e)(11) or Table 2001, may be automatically monitored by the asset account management software to ensure that all payments are timely made and FASB/IASB/GASB compliance is maintained for compliance and global harmonization.

In the case of the Alternate Plan, the administrative software will monitor both the portion attributable to the UNIQUE SOLUTION® and the Financial Management account to determine values.

The program may be implemented using a single dedicated computer or may comprise multiple computers that share information. For example, it is expressly contemplated that a single system can be implemented for modeling, while a second system may receive the data that corresponds to the selected employees and then implements and maintains the asset account. It is also expressly contemplated that different groups may be responsible for different portions of the programs implementation.

In view of this program the following modeling and asset account systems have been developed. Those of ordinary skill in the art will recognize that the present invention may be modified in keeping with the spirit of the present invention.

B. Modeling

The modeling program 200 is contemplated to be the first portion of the system that is used. The program 200 may reside on a computer or on a server. It is expressly recognized that the modeling program may be combined with other portions of the present invention or may be implemented separately.

There are several variable factors that may effect the Employer's decision to participate in the program. The modeling program permits multiple variables to be tested to see what impact the factors have on implementing the program. The modeling program is designed for use by the Employer, insurance company, program manager, employee or any combination thereof. The modeling program is designed to be used by a single entity but it is expressly contemplated that the modeling program may be divided into sub-parts that are performed by different entities.

When the Employer implements the program it can tie up its cash reserves. The Employer often uses its cash to fund the asset account to pay for premiums on the life insurance policy. The Employer will be provided an asset in line with FASB 87,106,158, EITF 85-4,06-04,06-05, GASB 25,27 and 43,45 and IASB 19 which must be monitored and compared with other investment opportunities the Employer would otherwise make. In an alternate embodiment, the Employer's costs will be offset by an economic evaluation of the impact on the Employer of the Benefit. The modeling program is thus designed to provide the Employer with relevant information so as to decide whether or not to implement and maintain the program.

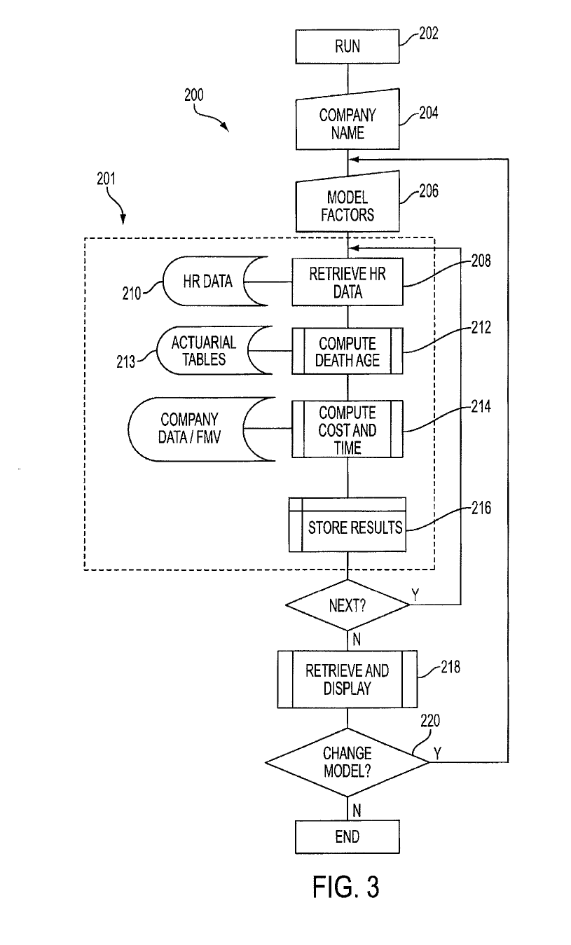

The modeling program 200 is shown in FIG. 3. The Employer may choose to run step 202, a model based on selected employees or based upon cost and length of investment. For example, a program can be modeled for a top executive. Alternatively, the Employer may identify a group of top executives, a cash amount available for the program and a preferred length of time for the program. The modeling program 200 may be used to identify which top executives are most likely to meet the Employer's objectives.

The model program has two basic inputs: a company identity input 204 and model factors 206 input step. These two inputs may be combined or may each comprise multiple inputs. With regard to input 204, it is important to identify the company that is involved, or at least its basic financial data (stock performance, cash, etc.), and the pool factors. The pool factors may comprise any factor used to select individuals for modeling. Pool factors may include an employee's name, age, length of service with the company, management status, etc. Step 204 may include all of Company X's data prior to consulting with Company X. After this initial information is provided, a compute costs program 201 is executed. The compute cost routine 201 takes the input data from steps 204 and 206 and combines the data with human resource information provided at step 208. The routine calculates the working life and the death age of the participant at 212 using input data or actuarial tables 213. At step 214 the routing generates the cost information that is then stored and/or displayed in conjunction with the input data at step 216.

It should be noted that the input parameters may be entered in ranges. If ranges are input, the modeling program may compute and display the results in ranges. It is expressly contemplated that not all data points between the two ranges need to be immediately calculated. A zoom feature may be provided that re-calculates data within a range for more detailed financial analysis by the Employer.

The retrieved HR data 208 comes from an HR database 210. That database 210 can reside in a separate system. The HR data used by the modeling program 200 includes age, sex, marital status, age of spouse, health, and other EWB data, etc. The retrieved HR data is used to compute the likely age of death of participants and working life at step 212 and computing the cost to the company 214 of the most likely time frame the UNIQUE SOLUTION® Plan, or the Alternate Plan will be completed in (the time period until the participant dies or working life) also at step 214. These computations may use information from internal databases or external databases. It is expressly contemplated that an interface program may be used to extract relevant information from existing databases. Alternatively, communication software may be used to obtain the relevant information from commercially available databases.

The modeling program 201 permits a number of different employees and company profiles to be analyzed. The results can be stored in the system 300 shown in FIG. 1 as shown in step 216 and be easily retrieved by the user at step 218. The results may be printed, displayed or otherwise sent to an intended recipient. Different employees or model factors can be selected at step 220 after the first set of results are retrieved and displayed in step 218.

It is important to recognize that at least the fair value or FMV and death ages of the participants are two items that are not known until the events occur. The uncertainty in these factors means that when results are analyzed, there are certain unknown factors. Thus, it is expressly contemplated that in an alternate embodiment the retrieve and display step 218 may comprise a weighting sub-routine that may be used to weigh those factors the Employer determines to be most important. For example, if the Employer determines that it may tie up ten million dollars in cash reserves but only for a time period of ten years, the time until working life terminates or death factor may be weighed more heavily. Pool participants can be identified who most likely will meet the company's objectives, and withdraw or die in ten years. Other factors that may be used in the weighing sub-routine include expiration date of options, type of options, Grant Price, length of employment or other data.

The weighing subroutine includes a list of all variables that the analysis is based upon which is retrieved and displayed. The Employer may then assign weights to each factor. A percentage scale or high, medium, low scale may be used. It is expressly contemplated that unassigned factors may be assigned a default value. After the data is analyzed in the conventional manner, the results are displayed based on the weigh of the factors and the effect that factor has on the end result. For example, a high designation on “age over 65” will result in those participants with ages over 65 being displayed first. If a high designation is given in another category, an individual satisfying both high designations will be listed first. Individuals with high designations in only one of the two categories will be listed below.

As those of ordinary skill in the art will appreciate, the computing steps required will depend on the input factors. The database information may likewise be inputted or retrieved from an available database.

C. Financial Management or Asset Account Administration Program

Once the company decides to implement the program and executes it, the management of the program shifts to the Financial Management Account recorded on the books of the company. The “asset account” is used to pay the life-insurance benefit. The Financial Management Account includes but is not limited to stochastic modeling and other efficient modeling may also monitor participant borrowing or a life insurance agent may perform this function. The Financial Management Account administration program may be implemented as a separate program than the modeling program above or may be combined therewith.

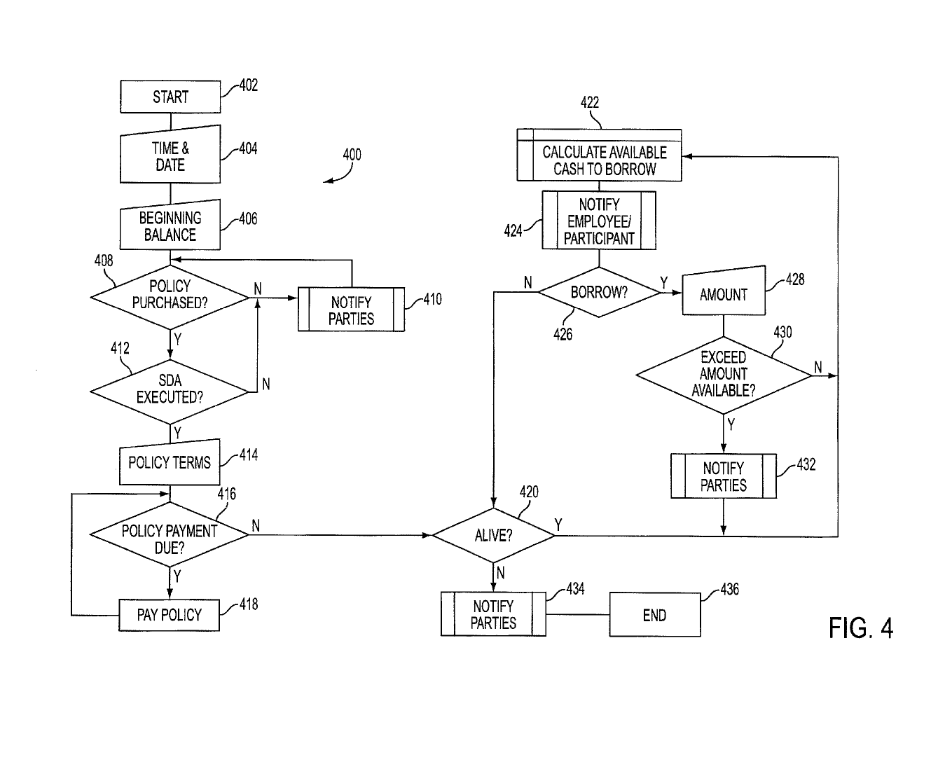

FIG. 4 shows a flow chart of an asset account administration program 400. The asset account management software 400 may be used to make sure that all of the formalities associated with implementing the UNIQUE SOLUTION® Plan, or the Alternate Plan are properly executed. For example, the software program may contain a Policy purchased input as well as a co-ownership endorsement executed input. If either of these inputs do not meet certain criteria, such as being properly executed and sent to an administrator, the asset account will not pay the n year premiums, e.g. over working life duration, on the Policy.

Once the program is successfully started at step 402, the program ensures the timely payment of the life insurance premiums. In step 404 the time and date are input. This input may be manual or electronic and is used to calculate when a certain number of effective years have past for tax purposes, e.g. working life. The beginning balance is input at step 406. The beginning balance is reasonable actuarially determined.

The account administration program then ensures that a Policy has been purchased at 408 and a co-ownership endorsement executed at 412. If either of these steps fails to meet certain pre-determined criteria the parties are notified at step 410. If the Policy and co-ownership endorsement are executed in electronic form, or subsequently placed in an electronic form, the software may be designed to automatically extract the required information, such as validation, proper naming of death beneficiary, etc. If the Policy terms are not automatically input, they are input at step 414.

The program then cycles through the working life and pays the actuarially determined amount against the Policy premiums at steps 416 and 418. It is expressly contemplated that the actuarially determined amount will be completed over the working life, but if it is not the program may be modified accordingly.

If the employee is still alive upon termination of the plan, then at step 420 the program calculates the amount that is available for borrowing on a tax free or reduced tax basis in step 422. The participant is notified in step 424, either manually or electronically that borrowing may begin. If the participant elects to borrow against the Policy, the amount that is being borrowed is input at 428. If the amount exceeds the amount available for borrowing, the parties are notified in step 432. This process continues until it is determined that the employee is no longer alive, at which point the parties are notified at step 434 and the program terminates at steps 436. During the time the Employer has carried the policy as an asset it may borrow against the policy in line with these provisions.

Those of ordinary skill in the art will recognize that this program may be modified and is not limited to the specific embodiment disclosed. For example, if the purchase of the Policy is automated, in addition to Policy information being input automatically, the program may be designed to exercise the co-ownership endorsement and automatically transfer funds upon the participant's death.

D. UNIQUE SOLUTION® Plan System

The present invention can be modified to work with all deferred compensation and benefit planning programs. This program has previously been referred to as the UNIQUE SOLUTION® Plan. The UNIQUE SOLUTION® Plan is similar to the DASO® Plan but uses the deferred income obligation of the company as the Spread or gain otherwise associated with the DASO® Plan. The program's administration is similar to that of the DASO® Plan with minor modification to the modeling program 200.

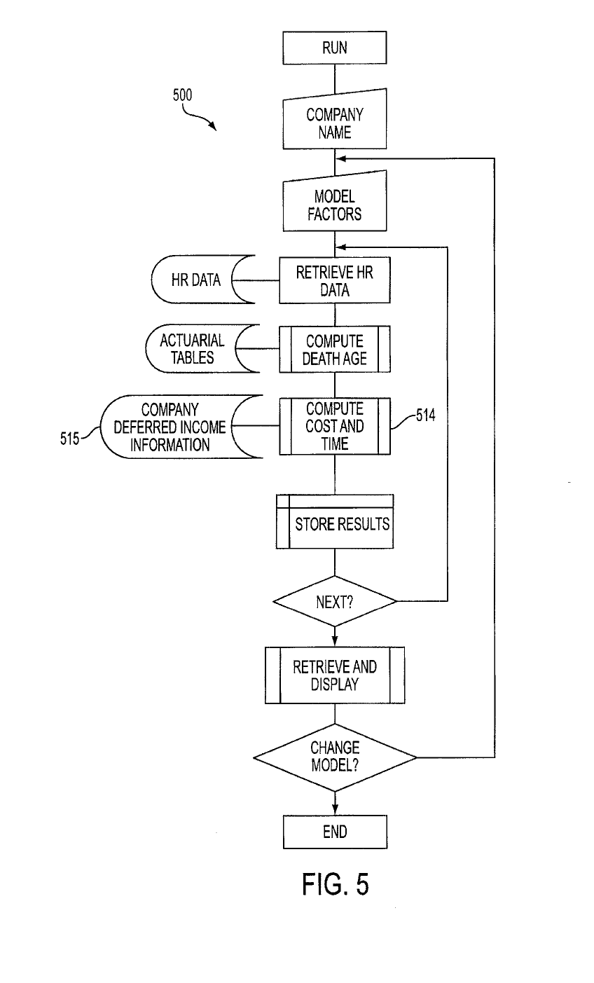

The Employer's obligation to the Employee in the form of deferred award instrument plan may be placed into a asset account and administered using a similar life insurance policy and endorsement. The cost to the company is likewise associated with the annually actuarially determined amount. FIG. 5 shows the UNIQUE SOLUTION® Plan modeling program 500. Step 514 is modified to retrieve deferred income information as opposed to stock option information. The deferred income information may be retrieved from database 515 that may be the same or different from database 214 shown in FIG. 3.

The Alternate Plan's system, methodology and modeling tracks that of the UNIQUE SOLUTION® Plan set forth in Part D above, but is used for a non-profit, governmental and employer, multinational corporations or pass-through entities and complies with Internal Revenue Service Code §61, 83, 101(j),409A 457(f)(2)(c) and §457(e)(11) and §501(c) It also complies with FASB GASB and IASB regulations.

E. The Alternate Plan System

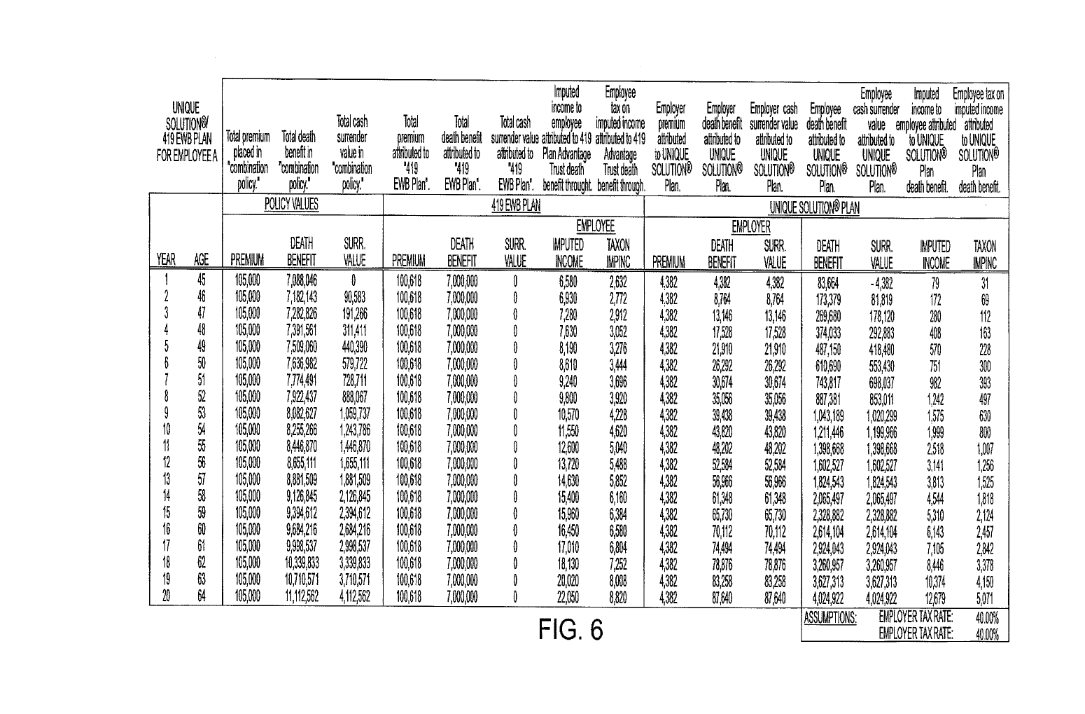

The present invention can also be modified to work with a combination UNIQUE SOLUTION®/EWB Plan which has already been referred to as the Alternate Plan. FIG. 6 is a chart depicting costs, benefits and values for the Alternate Plan. Under the Alternate Plan, the contributions are split between the EWB Plan and the UNIQUE SOLUTION®.

In view of all of the foregoing, those skilled in the art will appreciate that embodiments of the present invention provide a method of operating a benefits plan, the method including selecting a type of benefits plan to provide to employees, the benefits plan having a built-in co-ownership provision, obtaining a valuation for a present cost value of the benefits plan, ascertaining a future value of the benefits plan, identifying a future owner or recipient of benefits provided by the benefits plan, and funding the benefits plan based at least in part on the present cost value of the benefits plan, the future value of the benefits plan, the future owner or recipient of the benefits provided by the benefits plan, and results of stochastic modeling of data on which the present cost value, the future value of the benefits plan, the future owner or recipient of the benefits is based.

The benefits plan may be one of a qualified benefits plan, non-qualified benefits plan, employee welfare benefit plan, and post retiree benefits plan, and may be sponsored by at least one of a for-profit or non-profit entity.

The step of obtaining a valuation may include, among other things, determining a number of participants in the benefits plan, an amount of benefit to be provided by the benefits plan, a funding duration of the benefits plan, and when the benefit of the benefits plan is due.

The step of ascertaining a future value of the benefits plan may include, among other things, determining at least one of a likely number of recipients of the benefit, an expected return on investment of the benefits plan, mortality of participants, and how benefits are to be distributed.

Further, the step of funding may include at least one of purchasing life insurance, purchasing an annuity, or investing in capital markets. Which one or combination of the foregoing financial transactions may be selected based on stochastic modeling.

The method may also include purchasing life insurance on lives of employees, determining beneficiary designation, and determining duration of funding of the life insurance.

Furthermore, in one possible embodiment, the method may include paying a participant in the benefits plan an equivalent benefit to the benefit to which the participant would otherwise be entitled to under the benefits plan.

The method may still further include creating an asset on the books of a company sponsoring the benefits plan as a result of the step of funding. Preferably, the sponsor of the benefits plan realizes an economic benefit.

In addition, in a specific implementation, the benefits plan is a group term life benefit plan with respective employees owning a current death benefit so long as they remain employed by a sponsor of the benefits plan, and the benefits plan remains in force.

Those of ordinary skill in the art will recognize the wide commercial applicability of the invention set forth above. Those of ordinary skill in the art will recognize the large commercial use of the apparatus and method herein described to companies and financial investor service providers. Those of ordinary skill in the art will recognize that the invention herein described and claimed may be modified and is not limited to the specific embodiments herein described.

I claim:

1. A method of operating a benefits plan, comprising:
selecting a type of benefits plan to provide to employees, the benefits plan having a built-in co-ownership provision;
obtaining a valuation for a present cost value of the benefits plan;
ascertaining a future value of the benefits plan;
identifying a future owner or recipient of benefits provided by the benefits plan; and
funding, at least partially using a computer, the benefits plan based at least in part on the present cost value of the benefits plan, the future value of the benefits plan, the future owner or recipient of the benefits provided by the benefits plan, and results of stochastic modeling of data on which the present cost value, the future value of the benefits plan, the future owner or recipient of the benefits is based.

2. The method of claim 1, wherein the benefits plan includes at least one of a qualified benefits plan, non-qualified benefits plan, employee welfare benefit plan, and post retiree benefits plan.

3. The method of claim 2, wherein the benefits plan is sponsored by at least one of a for-profit or non-profit entity.

4. The method of claim 1, wherein the step of obtaining a valuation comprises determining a number of participants in the benefits plan, an amount of benefit to be provided by the benefits plan, a funding duration of the benefits plan, and when the benefit of the benefits plan is due.

5. The method of claim 1, wherein the step of ascertaining a future value of the benefits plan comprises determining at least one of a likely number of recipients of the benefit, an expected return on investment of the benefits plan, mortality of participants, and how benefits are to be distributed.

6. The method of claim 1, wherein the step of funding comprises at least one of purchasing life insurance, purchasing an annuity, or investing in capital markets.

7. The method of claim 6, wherein a decision regarding what type of funding to be used is based on stochastic modeling.

8. The method of claim 1, further comprising purchasing life insurance on lives of employees, determining beneficiary designation, and determining duration of funding of the life insurance.

9. The method of claim 1, further comprising paying a participant in the benefits plan an equivalent benefit to the benefit to which the participant would otherwise be entitled to under the benefits plan.

10. The method of claim 1, further comprising creating an asset on the books of a company sponsoring the benefits plan as a result of the step of funding.

11. The method of claim 1, wherein a sponsor of the benefits plan realizes an economic benefit.

12. The method of claim 1, wherein the benefits plan is a group term life benefit plan with respective employees owning a current death benefit so long as they remain employed by a sponsor of the benefits plan, and the benefits plan remains in force.
